(19) United States
(12) Patent Application Publication
(10) Pub. No.: US 2026/0113717 A1
(43) Pub. Date: Apr. 23, 2026

(54) ACCESS POINT AND TERMINAL AND COMMUNICATION METHOD PERFORMED BY THE ACCESS POINT AND TERMINAL

(71) Applicant: TP-Link Systems Inc., IRVINE, CA (US)

(72) Inventors: Junbin CHEN, Chengdu (CN); Yunpeng YANG, Shenzhen (CN)

(73) Assignee: TP-Link Systems Inc., IRVINE, CA (US)

(21) Appl. No.: 18/921,999

(22) Filed: Oct. 21, 2024

(51) Int. Cl. H04W 56/00; H04W 76/19

(52) U.S. Cl. CPC H04W 56/001; H04W 76/19

(57) ABSTRACT

This disclosure provides an access point (AP) and a terminal and a communication method performed by the access point and terminal. The AP can be a first AP, including: a transmitter, configured to transmit a first request for requesting the terminal to re-associate with the first AP, and a receiver, configured to receive a first response which is in response to the first request, wherein the first response indicates that the re-association of the terminal with the first AP succeeds.

### TECHNICAL FIELD

The present disclosure relates to wireless communication, in particular to an access point (AP) and terminal and a communication method performed by the access point and terminal.

### BACKGROUND

The roaming is an important technology in the field of Wi-Fi. When a mobile terminal (e.g., a STA) moves in an area covered by a network consisting of multiple APs, the roaming technology can make the terminal disconnect from the source AP and automatically associate and authenticate with the target AP, so as to obtain a better signal-to-noise ratio/higher throughput in the moved location.

For Wi-Fi 8, the task group TGbn is exploring ways to make the roaming process of the terminal more seamless, to reduce the delay and the performance loss caused by packet loss in roaming.

### SUMMARY

Based on the above, the present disclosure provides an access point (AP) and a terminal and a communication method performed by the access point and terminal.

In an aspect of the present disclosure, the present disclosure provides a first access point (AP), comprising: a transmitter, configured to transmit a first request for requesting a terminal to re-associate with the first AP, and a receiver, configured to receive a first response which is in response to the first request, wherein the first response indicates that the re-association of the terminal with the first AP succeeds.

In yet an aspect of the present disclosure, the present disclosure provides a terminal, comprising: a receiver, configured to receive a first request for requesting the terminal to re-associate with a first access point (AP), and a transmitter, configured to transmit a first response which is in response to the first request, wherein the first response indicates that the re-association of the terminal with the first AP succeeds.

In yet an aspect of the present disclosure, the present disclosure provides a communication method performed by a first access point (AP), comprising: transmitting a first request for requesting a terminal to re-associate with the first AP, and receiving a first response which is in response to the first request, wherein the first response indicates that the re-association of the terminal with the first AP succeeds.

In yet an aspect of the present disclosure, the present disclosure provides a communication method performed by a terminal, comprising: receiving a first request for requesting a terminal to re-associate with the first AP, and transmitting a first response which is in response to the first request, wherein the first response indicates that the re-association of the terminal with the first AP succeeds.

The present disclosure further provides a first access point (AP) comprising means for performing methods performed by the first AP as described according to various embodiments in the disclosure.

The present disclosure further provides a terminal comprising means for performing methods performed by the terminal as described according to various embodiments in the disclosure.

The present disclosure further provides a non-transitory computer-readable medium storing instructions, when executed by a processor, causing a transmitter and a receiver to perform methods as described according to various embodiments in the disclosure.

The present disclosure further provides a computer program product comprising instructions, when executed by a processor causes a transmitter and a receiver to perform methods as described according to various embodiments in the disclosure.

### BRIEF DESCRIPTION OF THE DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation to the present disclosure. In the drawings, unless otherwise explicitly indicated, the same reference numerals refer to the same components, steps or elements. In the accompanying drawings,

FIG. 1 shows a schematic diagram illustrating a method for roaming in the prior art;

FIG. 2 shows an example communication system in which the communication method according to an embodiment of the present disclosure may be applied;

FIG. 3 shows a flow diagram illustrating an example communication method performed by a first AP according to an embodiment of the present disclosure;

FIG. 4 shows a flow diagram illustrating an example communication method performed by a first AP according to an embodiment of the present disclosure;

FIG. 5 shows a flow diagram illustrating an example communication method performed by a terminal according to an embodiment of the present disclosure;

FIG. 6 shows a schematic diagram illustrating an example interaction among a terminal, a source AP, and a target AP when the method according to an embodiment of the present disclosure is applied;

FIG. 7 is a schematic diagram of a communication device, for example an AP or a terminal, according to an embodiment of the present disclosure;

FIG. 8 shows an example configuration of a communication device, for example an AP, according to an embodiment of the present disclosure; and

FIG. 9 shows an example configuration of a communication device, for example a non-AP or a STA, according to an embodiment of the present disclosure.

### DETAILED DESCRIPTION

The technical solution of the present disclosure will be clearly and completely described below in conjunction with accompanying drawings. Obviously, the described embodiments are part of embodiments of the present disclosure, but not all of them. Based on the embodiments in the present disclosure, all other embodiments obtained by ordinary skilled in the art without making any creative efforts fall within the scope of protection of the present disclosure.

In the description of the present disclosure, it should be noted that orientations or positional relationships indicated by terms such as “center”, “upper”, “lower”, “left”, “right”, “vertical”, “horizontal”, “inside” and “outside” are based on orientations or positional relationships shown in the drawings, only for the convenience of describing the present disclosure and simplifying the description, instead of indicating or implying the indicated device or element must have a particular orientation. In addition, terms such as “first”, “second” and “third” are only for descriptive purposes, whereas cannot be understood as indicating or implying relative importance. Likewise, words like “a”, “an” or “the” do not represent a quantity limit, but represent an existence of at least one. Words like “include” or “comprise” mean that an element or an object in front of the said word encompasses those ones listed following the said word and their equivalents, without excluding other elements or objects. Words like “connect” or “link” are not limited to physical or mechanical connections, but may include electrical connections, whether direct or indirect.

In the description of the present disclosure, it should be noted that, unless otherwise explicitly specified and limited, terms such as “mount”, “link” and “connect” should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the specific meanings of the above terms in the present disclosure may be understood on a case-by-case basis.

In addition, technical features involved in different embodiments of the present disclosure described below may be combined with each other as long as no conflicts occurs therebetween. Further, figures are merely for illustration and are simplified for brevity and thus may be not exactly the same as practical implementations. For example, in figures, the processing delay of devices may be omitted.

In the present disclosure, an AP, which may be interchangeably referred to as a wireless access point (WAP), is a communication device that can communicate with a non-AP (e.g., STA) in a WLAN via one or more links and that allows the non-AP to be connected to a wired network. The AP is usually connected to a router (via a wired network) as a standalone device, but it can also be integrated with or employed in the router.

Likewise, in the present disclosure, a non-AP (e.g., a station or terminal, which is interchangeably referred to as an STA) is a communication device that can communicate with an AP via one or more links. The STA may be any device that contains an IEEE 802.11-conformant media access control (MAC) and physical layer (PHY) interface to the wireless medium (WM). For example, an STA may be a laptop, a desktop personal computer (PC), a personal digital assistant (PDA), an access point, or a Wi-Fi phone in a WLAN environment. The STA may be fixed or mobile. In the WLAN environment, the terms “STA”, “terminal”, “wireless terminal”, “user”, “user device”, and “node”are often used interchangeably.

In the present disclosure, a STA in a WLAN may work as an AP at a different occasion, and vice versa. This is because communication devices in the context of IEEE 802.11 (Wi-Fi) technologies may include both STA hardware components and AP hardware components. In this manner, the mode of a communication device may switch between a STA mode and an AP mode, based on actual WLAN conditions and/or requirements. In various embodiments below, a non-AP STA may refer to an STA or terminal in a WLAN that is not implemented as an AP.

As described above, currently, roaming is an important technology in the field of Wi-Fi, which can make the STA disconnect from the source AP and automatically associate and authenticate with the target AP, so as to obtain a better signal-to-noise ratio/higher throughput in the moved location. FIG. 1 shows a schematic diagram illustrating a method for roaming in the prior art. As shown in FIG. 1, in the current method for roaming, the terminal 110 (e.g., a STA) may initiate the roaming from the source AP 120 to the target AP 130 by transmitting a roaming request to the source AP 120 with which the STA 110 is associating. After receiving the roaming request, the source AP 120 may first transmit a roaming acknowledgment (ack) to the terminal 110 to indicate that it has received the roaming request. Then the source AP 120 may perform the near static context transfer with the target AP 130. Specifically, the source AP 120 may transit the near static context to the target AP 130, wherein the near static context contains some necessary information for the re-association of the terminal with the target AP, and will not change frequently over the data transmission, such as the SSID, the rate information supported by STA, and various capability information (e.g., VHT capability information, and HE capability information, etc.). After receiving the near static context and completing preparation operations related to the roaming of the terminal 110 from the source AP 120 to the target AP 130, the target AP 130 may transmit a response to the source AP 120 to indicate the near static context transfer and the preparation operations are done. Thereafter, the source AP 120 may transmit a roaming response to the terminal 110 to indicate that the target AP 130 has completed the preparation operations related to the roaming of the terminal 110 from the source AP 120 to the target AP 130. After receiving the roaming response, the terminal 110 may transmit a re-association request to the target AP 130 (e.g., via the source AP 120, or via the air) to request to associate with the target AP 130. Then, the target AP 130 may transmit a re-association response to the terminal 110. Up to now, the roaming of the terminal 110 from the source AP 120 to the target AP 130 is completed. Then data transmission can be performed between the terminal 110 and the target AP 130.

Additionally, between the transmission of the re-association request and re-association response, dynamic context transfer may be performed between the source AP 120 and the target AP 130. The dynamic context may include information indicating changes in information (i.e., contents) indicated by the near static context between time T1 (i.e., a time at which the source AP 120 transmits the near static context) and time T2 (i.e., a time at which the source AP 120 transmits the dynamic static context). Exemplarily, the dynamic context may comprise at least one of a sequence number (SN), a packet number (PN), or a block acknowledgment (BA) related to data transmission between the terminal 110 and the source AP 120, between T1 and T2.

As to the above current method for roaming, there are the main following questions. Firstly, it requires the target AP to inform the source AP that the target AP has completed the preparation operations, and then the current AP informs the terminal that the target AP has completed the preparation operations. Thereafter, the terminal knows that the target AP has completed the preparation operations and thus it may transmit the re-association request. However, considering that the terminal wants to roam, which usually means that the communication quality between the terminal and the target AP is higher than that between the terminal and the current AP, in this case, if it is still required that the current AP forwards the information indicating that the target AP has completed the preparation operations, this obviously reduces the efficiency of the roaming.

Secondly, between time T2 (i.e., the time at which the source AP 120 transmits the dynamic context) and T3 (i.e., a time at which the terminal 110 receives the re-association response), the data transmission between the terminal and any AP (either the source AP 120 or the target AP 130) can't be performed, which may affect the seamless roaming of the terminal. This is because, if the data transmission between the terminal 110 and the source AP 120 is performed, at time T2 when the source AP 120 transmits the dynamic context, the source AP 120 can't know whether the data transmission between the terminal 110 and the source AP between the time T2 and T3 is successful or not, so that the source AP 120 can't provide information related to the data transmission between the time T2 and T3 in the dynamic context transmitted at the time T2. Therefore, when the terminal 110 is associated with the target AP 120, the target AP 120 does not know whether the data transmission between time T2 and T3 is successful or not and thus can't perform the re-transmitting of the lost data, so there is the risk of a loss of the data transmission between time T2 and T3. Based on this, the current technology generally specifies no data transmission between the terminal 110 and the source AP, between the time T2 and T3 is performed. Further, between the time T2 and T3, since the re-association of the terminal 110 with the target AP 130 is not completed, the data transmission can't be performed between the terminal 110 and the target AP 130.

Based on the above, the disclosure provides an access point and a terminal and communication method performed by the access point and terminal, which can at least address the above problems in the current roaming technology and thus facilitate the seamless roaming of the terminal.

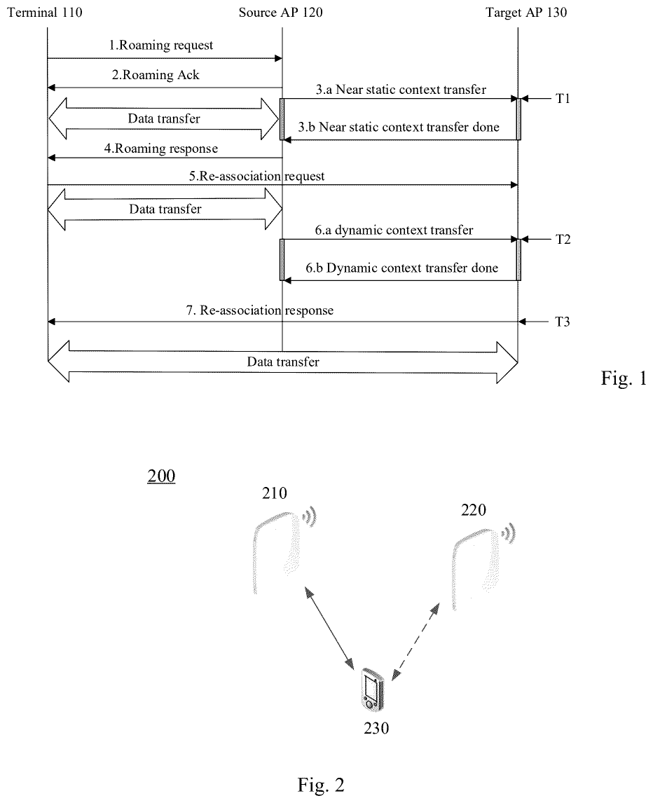

FIG. 2 shows an example communication system 200 in which the communication method according to an embodiment of the present disclosure may be applied. As shown in FIG. 2, the communication system 200 may be a communication system comprising two APs, AP 210 and AP 220. Each of AP 210 and AP 220 may connect to a network (e.g., an internet) (not shown) via wireless or wired connection. Each of the APs in the communication system 200 may communicate with one or more terminals (only one terminal is shown in FIG. 2 for brevity), so that the one or more terminals may connect to the network (e.g., the internet). Further the AP 210 and AP 220 may communicate with each other wirelessly or wired.

In the example of communication system 200 shown in FIG. 2, the terminal 230 is associating with the AP 110, and due to some reasons (e.g., the moving of the terminal 230), the terminal 230 may need to re-associate to the AP 220. In this case, the terminal 230 may re-associate to the AP 220 by the method according to an embodiment of the present disclosure which will be described in detail below. During the re-association of the terminal 230 from the AP 210 to the AP 220, the AP 210 may be referred to as the source AP, and the AP 220 may be referred to as the target AP. In this disclosure, the re-association means the association of the terminal is switched from an AP (i.e., the source AP) to another AP (i.e., the target AP). In addition, the target AP can be determined through any current method (e.g., the 802.11k/v/r based on method) or the method developed in the future.

Notably, it should be understood that the communication system shown in FIG. 2 is just an example, but not a limitation to the present disclosure. For example, although in FIG. 2, only two APs and one terminal which is a cellphone are shown, the communication system in which the communication method according to an embodiment of the present disclosure may be applied can comprise more APs and terminals which are various types, such as cellphone, a laptop, a desktop personal computer (PC) and the like.

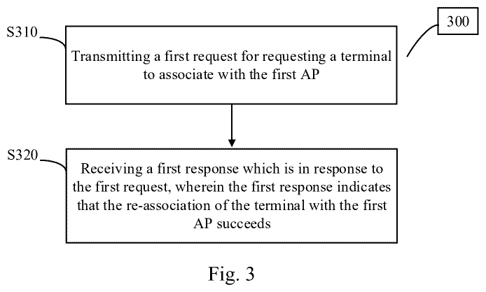

FIG. 3 shows a flow diagram illustrating an example communication method 300 performed by a first AP (i.e., the target AP) according to an embodiment of the present disclosure. As shown in FIG. 3, the method 300 may start at block S310. At block S310, a first request for requesting a terminal to re-associate with the first AP is transmitted. Compared with the conventional re-association response transmitted by the AP in the prior art, the first request may omit a large part of static capability information, e.g., the static capability information of the target AP. This is because the omitted static capability information may be transmitted to the terminal in the roaming response shown in FIG. 6.

Moreover, the first request may comprise parameters to be negotiated with the terminal. For example, the parameters may be parameters that the first AP selects to replace those (e.g., the bandwidth of the first AP required by the terminal) transmitted in a first context (which may be the above near static context in an example, and will be described below in detail) but not supported by the first AP. For another example, the parameters may be parameters that are not included in the first context, but the first AP wants to negotiate with the terminal. In this manner, it is avoided that unsuitable parameters included in the first context are used for the re-association of the terminal with the first AP.

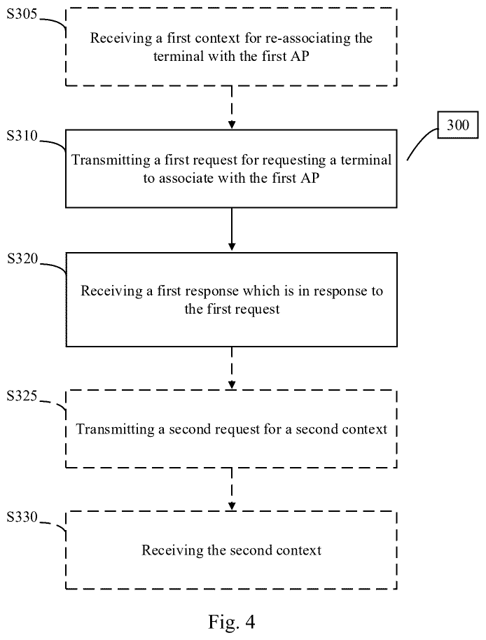

Exemplarily, the transmitting of the first request may be performed after the first AP completes the preparation operations related to the re-association of the terminal from a source AP (i.e., a second AP) to the target AP (i.e., the first AP). For example, the preparation operations related to the re-association of the terminal from the second AP to the first AP may be based on receiving, by the first AP, a context for re-associating the terminal with the first AP (i.e., the first context shown in FIG. 6), e.g., via a backhaul between the first AP and the second AP (i.e., the wired medium) or via the air (i.e., the wireless medium), and thus the transmitting of the first request can be performed after receiving the first context. In this case, the method 300 may further comprise receiving the first context for re-associating the terminal with the first AP, e.g. via the backhaul between the first AP and the second AP or via the air, as shown in block S305 in FIG. 4. The transfer of the first context via the backhaul between the first AP and the second AP does not affect the data transmission between the terminal and the second AP, and thus in this case, during the transfer of the first context, the data transmission between the terminal and the second AP can be performed.

The first context may include any information related to re-associating the terminal with the first AP. For example, the first context may include capability information of the terminal and the first AP (e.g., bandwidths supported by the terminal and the first AP) which may be static, and information related to data transmission (i.e., a session, for example, block acknowledge (BA) session) between the terminal and the second AP which may be dynamic. The information related to the data transmission between the terminal and the second AP may include the SN\PN information of data that has been transmitted by the second AP to the terminal successfully at the time of transmitting the first context, and/or information related to data (i.e., an amount of the data, and/or the SN/PN of the data) which is buffered in the second AP and will be transmitted to the terminal by the second AP after transmitting the first context and before the completion of the re-association of the terminal with the first AP.

Returning back to FIG. 3, at block S320, a response (i.e., a first response, which may be a response frame) which is in response to the first request is received. The first response may indicate that the re-association of the terminal with the first AP succeeds. When receiving this response indicating that the re-association of the terminal with the first AP succeeds, it is determined that the re-association of the terminal with the first AP (i.e., the switching of the association of the terminal from the second AP (i.e., the source AP) to the first AP (i.e., the target AP)) is completed, and then data transmission between the terminal and the first AP can be performed.

Exemplary, in a case where the first response (e.g., the response frame) which is in response to the first request is transmitted by the terminal regardless of the re-association of the terminal with the first AP succeeds, the response frame may indicate whether the re-association of the terminal with the first AP succeeds via a field (i.e., a first field) in the frame. For example, the response frame may indicate that the re-association of the terminal with the first AP succeeds through a first value (e.g., 1) of the first field in a case where it is determined that the re-association succeeds, and the response frame may indicate that the re-association of the terminal with the first AP fails through a second value (e.g., 0) of the first field in a case where it is determined that the re-association fails. Additionally, the response frame may contain another field (i.e., a second field) indicating different reasons for the failure through different values of the second field. Exemplarily, assuming that the reasons for the failure comprise: the key verification (which will be described below) is not correct, the terminal does not support the parameters (e.g., a certain function) proposed by the target AP in the first request, or the terminal is not ready to re-associate with the target AP, and that the second field includes two bits, the value 00 of the second field may indicate that the reason for the failure is that the key verification is not correct, the value 01 of the second field may indicate that the reason for the failure is that the terminal does not support the parameters proposed by the target AP, the value 10 of the second field may indicate that the reason for the failure is that the terminal is not ready to re-associate with the target AP, and the value 11 of the second field may be reserved. Alternatively, indicating whether the re-association of the terminal with the first AP succeeds and indicating the reasons for the failure may be jointly coded. That is, a single field instead of two separate fields may be used to indicate whether the re-association of the terminal with the first AP succeeds and indicate the reasons for the failure. Exemplarily, assuming that the reasons for the failure comprise: the key verification is not correct, the terminal does not support the parameters proposed by the target AP, or the terminal is not ready to re-associate with the target AP, and that the single field includes two bits, the value 00 of the single field may indicate that the re-association of the terminal with the target AP fails and that the reason for the failure is that the key verification is not correct, the value 01 of the single field may indicate that the re-association of the terminal with the target AP fails and that the reason for the failure is that the terminal does not support the parameters proposed by the target AP, the value 10 of the single field may indicate that the re-association of the terminal with the target AP fails and that the reason for the failure that the terminal is not ready to re-associate with the target AP, and the value 11 of the second field may indicate that the re-association of the terminal with the target AP succeeds. This joint coding may reduce the bits of the first response.

Alternatively, in a case where the first response which is in response to the first request is transmitted by the terminal only when the re-association of the terminal with the first AP succeeds, it may be determined that the re-association of the terminal with the first AP succeeds as long as receiving this response. In this case, the first AP may start a timer after transmitting the first request. If the first AP does not receive the first response which is response to the first request till the expiration of the timer, the first AP may determine that the re-association of the terminal with the first AP does not succeed. Then, the first AP may terminate the re-association of the terminal with the first AP or re-transmit the first request.

Further, in a case where the first request comprises the parameters to be negotiated with the terminal, the terminal may determine whether to accept the parameters and thus the first response may comprise an indication indicating whether the terminal accepts the parameters. Moreover, during the transmission of the first request and the first response which is in response to the first request, a key verification may be performed by encrypting at least a part of the first request and the first response with a negotiated key (for example, the negotiated PTK). The key can be negotiated in the preparation operations (for example, the nonces that are required in the derivation of PTK can be exchanged via the roaming request/response and the context transfer steps). In this manner, not only there is no need to perform a separate key verification, but also the key verification can be performed early, thereby facilitating the efficiency of the roaming of the terminal.

Additionally and optionally, the data transmission between the terminal and the second AP may be performed between first time and second time. The first time is a start time of transmitting the first context by the second AP, and the second time is a start time of re-association of the terminal with the first AP or an end time of the re-association of the terminal with the first AP. The start time of the re-association of the terminal with the first AP may be a time of transmitting the first request, and the end time of the re-association of the terminal with the first AP may be a time of receiving the first response. In practice, considering the transmission time between the terminal and the AP (e.g., the first or the second AP) is short, and thus can be omitted, the second AP that transmits the first and a second context which will be described below may determine that the time when it receives the first request is the start time of the re-association of the terminal with the first AP, and the time when it receives the first response indicating the re-association of the terminal with the first AP succeeds is the end time of the re-association of the terminal with the first AP. In an embodiment, the second AP can receive the first request and the first response indicating that the re-association of the terminal with the first AP succeeds from the first AP. That is, the first AP forwards the first response after receiving it. In another embodiment, the second AP can receive the first request and the first response indicating that the re-association of the terminal with the first AP succeeds from the terminal. That is, the terminal forwards the first request after receiving it. In another embodiment, the second AP can receive the first request from the first AP, and receive the first response indicating that the re-association of the terminal with the first AP succeeds from the terminal. In this way, no forwarding is required.

In the above case (i.e., the data transmission between the terminal and the second AP may be performed between the first time and the second time), after receiving the first response indicating that the re-association of the terminal with the first AP succeeds, optionally, a second request for a second context may be transmitted to the second AP as shown in block S325 of FIG. 4, e.g., via a backhaul (i.e., the wired medium) between the first AP and the second AP or via the air (i.e., the wireless medium). Then the second context may be received from the second AP, e.g., via the backhaul between the first AP and the second AP or via the air, as shown in block S330 of FIG. 4. Notably, between transmitting the second request and receiving the second context, the data transmission between terminal and the first AP (i.e., transmitting data to the terminal and/or receiving data from the terminal) can be performed, since the terminal has been associated with the first AP at this time.

The second context may comprise a dynamic context. Exemplarily, the second context may include information indicating changes in information (i.e., contents) indicated by the first context between the first time and the second time, e.g., information related to the data transmission between the terminal and the second AP, between the first time and the second time. For example, the information related to the data transmission may include the SN\PN information of data that has been transmitted to the terminal by the second AP between the first time and the second time, and the acknowledge information (e.g., the BA) of the transmitted data. Of course, the second context may include other information, for example, a resource request, e.g., for requesting the first AP to perform the data transmission that is not performed successfully between the terminal and the second AP between the first time and the second time.

Moreover, since the data transmission between the terminal and the second AP may be performed between the first time and the second time, there is a possibility that a part or all of the data transmission fails. Further, there may be some data that are buffered in the second AP but do not start to transmit to the terminal since the time duration between the first time and the second time is too short to transmit all the buffered data. These data (i.e., the data that is transmitted but fails to be transmitted to the terminal and/or the data that is not transmitted to the terminal) may be collectively referred to as the data that is not transmitted to the terminal successfully. In this case, the method according to the embodiment of the present disclosure can further comprise receiving the data from the second AP that is not transmitted to the terminal successfully, and transmitting the received data to the terminal.

In the above, the communication method performed by the first AP (i.e., the target AP in the roaming process) is described in connection with the FIGS. 3 and 4. Different from the current roaming, in which the target AP informs the source AP that it has completed the preparation operations related to the roaming of the terminal, then the source AP informs the terminal that the target AP has completed the preparation operations, and finally the terminal transmits the re-association request to the target AP, in the method of the disclosure, the target AP directly transmits the re-association request to the terminal after completing the preparation operations, which may omit the forwarding of the information related to that the target AP has completed the preparation operations by the source AP, thereby improving the efficiency of the roaming of the terminal. Further, since the data transmission between the terminal and the source AP can be performed till the terminal associates with the target AP, the seamless roaming of the terminal can be facilitated.

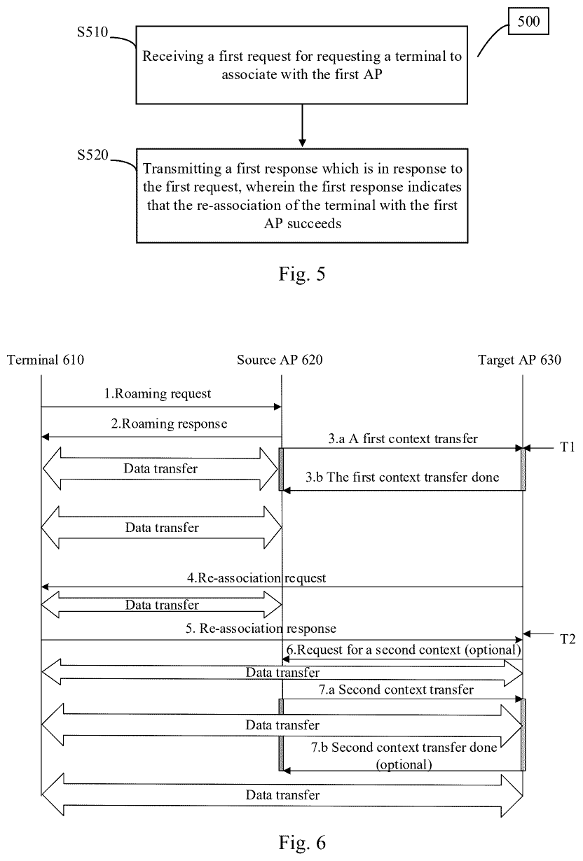

In the following, the disclosure will describe the communication method performed by the terminal in connection with FIG. 5.

FIG. 5 shows a flow diagram illustrating an example communication method 500 performed by a terminal according to an embodiment of the present disclosure. As shown in FIG. 5, the method 500 may start at block S510. At block S510, a first request for requesting a terminal to associate with the first AP is received. Then, at block S520, a first response which is in response to the first request is transmitted. The first response may indicate that the re-association of the terminal with the first AP succeeds. The first request and the first response are the same as those described above, which are not repeated herein for brevity.

In addition, as described above, the first request may include the parameters to be negotiated with the terminal. In this case, the method performed by the terminal according to an embodiment of the present disclosure may further comprise determining whether to accept the parameters. Accordingly, the first response may comprise an indication indicating whether the terminal accepts the parameters. Further, the method performed by the terminal according to an embodiment of the present disclosure may further comprise transmitting the first request to the second AP (i.e., the source AP) after receiving the first request, as described above. Moreover, the data transmission between the terminal and the second AP may be performed between the first time and the second time, as described above. The first time is the start time of transmitting the first context, and the second time is the start time of re-association of the terminal with the first AP or the end time of the re-association of the terminal with the first AP, which have been described above in detail and thus are not repeated herein for brevity.

Notably, the method performed by the terminal according to an embodiment of the present disclosure may further comprise operations described above in connection with FIGS. 3 and 4 as long as there is no contradiction therebetween.

FIG. 6 shows a schematic diagram illustrating an example interaction among a terminal 610, a source AP 620, and a target AP 630 when the method according to an embodiment of the present disclosure is applied. Interactions shown in FIG. 6 may be performed after the target AP 630 is determined by the terminal 610 through any current method or the method developed in the future. As shown in FIG. 6, when the method for roaming according to an embodiment of the present disclosure is applied, the interactions may comprise at least the following.

1. The terminal 610 transmits a roaming request to the source AP 620 (i.e., the first AP) to request roaming to the target AP 630.

2. The source AP 620 transmits a roaming response to the terminal 610 to respond to the roaming request, which carries the static capability information of the target AP 630, etc. Herein, it is assumed that the static capability information has been exchanged between APs in advance through the interface among the APs.

Then, the first context transfer is performed between the source AP 620 and the target AP 630, comprising:

3a. The source AP 620 transmits the first context to the target AP 630. The first context includes static information (such as the capability information of the terminal 610 and the BA session information), and dynamic information. The dynamic information such as the SN\PN may be divided into two parts: 1) the SN\PN information of data that has been transmitted by the source AP 620 at the time of transmitting the first context, and 2) the SN\PN information of the buffered data that the source AP 620 will continue to transmit to the terminal 610 after the transmission of the first context (whether the data corresponding to this SN\PN is successfully transmitted or not, the source AP 620 still doesn't know at this time).

In addition, when the source AP 620 starts the context transmission with the target AP 630, the distributed system (DS) routing map may be switched to the target AP 630 from the source AP 620, so that the new data transmitted from the DS to the terminal 610 is routed to the target AP 630 instead of the source AP 620 for caching. Moreover, as shown in FIG. 6, during and after the source AP 620 transmitted the first context, the data transmission between the terminal 610 and the source AP 620 may continue to be performed till the terminal 610 associates to the target AP 630 (i.e., between T1 and T2 shown in FIG. 6). For this data transmission during between T1 and T2, a transient context may be maintained by the source AP 620 to record whether this data transmission is successful.

3b. The target AP 630 informs the source AP 620 that the first context transfer is Done.

4. The target AP 630 transmits a re-association request (i.e., the first request as described above) to the terminal 610, indicating that the context transfer is completed, the roaming is ready, and the terminal 610 can seamlessly switch to the target AP 630 for subsequent communication.

5. When the terminal 610 receives this re-association request, it transmits a re-association response to the target AP 630 to confirm the completion of roaming. Thereafter, the data transmission between the terminal 610 and the target AP 630 can be performed.

Compared with the conventional re-association request generated by the terminal in the prior art, this re-association request according to the embodiment of the disclosure is more concise. This is because a large part of static capability and other information has been transmitted to the target AP 630 through the context exchange step mentioned above, so that the large part of the information can be omitted in the re-association request. Further, the main function of this re-association response is to respond to and confirm the receipt of the re-association request. Therefore, the transmission of the re-association request and the re-association response can be done quickly. In addition, as described above, the re-association request/re-association request interaction here can also realize the key verification function (e.g., pass the key (PTK) verification function) between the target AP 630 and the terminal 610.

Then since the data transmission between T1 and T2, the second context transfer can be performed between the source AP 620 and the target AP 630, comprising:

6. after the target AP 630 receives the re-association response, the target AP 630 may transmit a request for a second context to the source AP 620;

7.a. the source AP 620 transmits the second context to the target AP 630 as a response to the request for the second context; and

7.b the target AP 630 informs the source AP 620 that the second context transfer is done (in some embodiment, this operation can be omitted).

Notably, at the same time when the second context transfer is performed between the source AP 620 and the target AP 630, the data transmission between the terminal 610 and the target AP 630 can be performed.

Moreover, for those skilled in the art can better understand information related to the data transmission (e.g., BA session) included in the first and the second context, the disclosure will give a specific example below to illustrate it.

In FIG. 6, when the source AP 620 is transmitting the first context, if the first context transmitted by the source AP 620 to the target AP 630 can only indicate that “the data with SN=1˜10 has been confirmed to be successfully transmitted to the terminal” and the data with SN=11˜13 is transmitted after the first context is transmitted, the starting SN (SSN) of the BA context has actually changed, and thus the SSN obtained by the target AP 630 through the first context is actually lagging. In this case, if the target AP 630 still uses the SSN of 10 indicated in the first context to transmit the data to the terminal 610 after the completion of the re-association of the terminal 610 with the target AP 630, the data transmitted from the target AP 630 to the terminal 610 may not succeed.

To solve the above problem, the disclosure proposes that the source AP 620 may indicate that the data with SN=1˜10 has been confirmed to be successfully transmitted to the terminal 610, and the data with SN=11˜13 is still in the queue of the source AP 620 and ready to be transmitted to the terminal 610 after the first AP is transmitted. (Notably, this is merely an example of information related to data transmission but not limitation. When implementing, similar information can be indicated in various ways.) When the first context transmission is completed, the target AP 630 will know: the data with SN=1˜10 has been confirmed to be successfully transmitted to the terminal 610, whether the data with SN=11˜13 is successfully transmitted to the terminal 610 needs to be confirmed from the source AP 620 later, and the target AP 630 may directly transmit the data with SSN=14 to terminal 610. Accordingly, the second context can indicate whether the data with SN=11˜13 is successfully transmitted to the terminal 610.

From the above description, it can be seen that the target AP 630 actually has the information about the BA session with the terminal 610 at the moment of completing the first context transfer, and only needs to carry out the interaction of the re-association request and the re-association request to activate this BA session. Once activated (i.e., receiving the re-association response), the target AP 630 can immediately send the subsequent new data with SN=14 . . . from DS to terminal 610. Whether these data with SN=11˜13 are transmitted successfully to the terminal 610 will be known from the second context. If there are some data are not transmitted successfully to the terminal 610, the source AP 620 may indicate it in the second context and then the target AP 630 may request the source AP 620 to retransmit the data that is not transmitted successfully to the terminal 610 to it, or the source AP 620 directly forward this data to the target AP 630. Then, the target AP 630 can transmit this data to the terminal 610.

Notably, it should be understood that the interactions among the terminal 610, the source AP 620, and the target AP 630 when the method according to the embodiment of the present disclosure is applied shown in FIG. 6 are just examples, but not limitations to the present disclosure. The interactions may comprise more or less operations shown in FIG. 6. For example, the interactions may omit the operation of request for a second context. In this case, the source AP 620 may directly transmit the second context after receiving the re-association response e.g., from the terminal 610 as described above. For another example, the interactions may further comprise the operation of transmitting the re-association request to the source AP 620 by the terminal after receiving it from the target AP 630.

In the above, the communication methods (e.g., methods 300 and 500) performed by the first AP (i.e., the target AP) and the terminal are described in connection with FIGS. 2-6. In the method of the disclosure, the target AP can directly transmit the re-association request to the terminal after completing the preparation operations of the roaming, which may omit the forwarding of the information related to that the target AP has completed the preparation operations by the source AP, thereby improving the efficiency of the roaming of the terminal. Further, since the data transmission between the terminal and the source AP can be performed till the terminal associates with the target AP, the seamless roaming of the terminal can be facilitated.

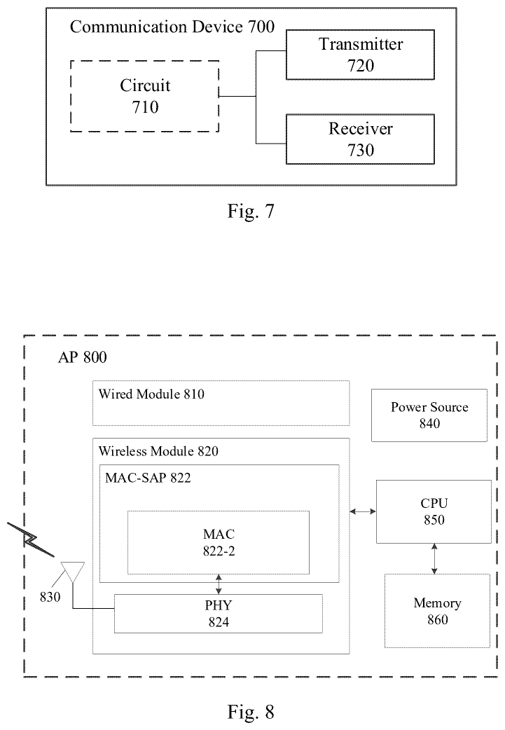

In the following, the disclosure will describe the communication device (e.g., an AP or a terminal) in connection with FIGS. 7-9.

FIG. 7 is a schematic block diagram of a communication device 700, for example, an AP or a terminal, according to an embodiment of the present disclosure. As shown in FIG. 7, the communication device 700 can comprise a circuit 710, a transmitter 720 and a transceiver 730. The communication device 700 can function as an AP (the first AP or the second AP as described above). Exemplarily, when the communication device 700 functions as the first AP, the transmitter 720 may be configured to transmit a first request for requesting a terminal to re-associate with the first AP, and the receiver 730 may be configured to receive a first response which is in response to the first request. The first response indicates that the re-association of the terminal with the first AP succeeds. When the communication device 700 functions as the second AP, the transmitter 720 may be configured to transmit a first context for re-associating the terminal with the first AP, and a second context after receiving the first response indicating that the re-association of the terminal with the first AP succeeds. The second context includes information indicating changes in information indicated by the first context between first time and second time. The first time is a start time of transmitting the first context, and wherein the second time is a start time of re-association of the terminal with the first AP or an end time of the re-association of the terminal with the first AP. The receive 730 may be configured to receive the request for the second context.

When the communication device 700 functions as the terminal, the receiver 730 may be configured to receive a first request for requesting the terminal to re-associate with the first AP, and the transmitter 720 may be configured to transmit a first response which is in response to the first request. The first response indicates that the re-association of the terminal with the first AP succeeds. The circuit 710 may be configured to perform operations related to the method according to the embodiment of the present disclosure. For example, in a case where the first request comprises parameters to be negotiated with the terminal, the circuit may be configured to determine whether to accept parameters. Accordingly, the first response may comprise an indication indicating whether the terminal accepts the parameters.

In addition, the circuit 710, the transmitter 720, and/or the receiver 730 may be further configured to perform other operations described above with reference to FIGS. 2-6, as long as there is no contradiction among these operations. Notably, although in FIG. 7, the transmitter 720, and the receiver 730 are shown as separate units, they may be located in a single unit or form a single unit (i.e., a transceiver).

FIG. 8 shows an example configuration of a communication device 800, for example an AP, according to an embodiment of the present disclosure. The communication device 800 may include a wired module 810, a wireless module 820, at least one antenna 830 (for the sake of simplicity, only one antenna is shown in FIG. 8), a power source 840, a central processing unit (CPU) 850 and at least one memory 860. The wireless module 820 may further comprise a MAC-SAP 822 (i.e., the MAC sublayer) and PHY 824 (i.e., the PHY sublayer). The MAC-SAP 822 can comprise MAC 822-2.

The wireless module 820 and the antenna 830 may function together as a transmitter and/or a receiver of the communication device 800 (e.g., the transmitter 720/or the receiver 730 shown in FIG. 7), configured to perform related operations of methods (e.g., methods 300 and 500) as described in the present disclosure. The wireless module 820 and the CPU 850 may function together as a circuit of the communication device 800 (e.g., the circuit 710 shown in FIG. 7), configured to perform related operations of methods (e.g., methods 300 and 500) as described in the present disclosure. In addition, it should be understood that although FIG. 8 shows the MAC-SAP comprises only one MAC, more than one MACs may be comprised in the MAC-SAP. The configuration of the communication device (e.g., AP) shown in FIG. 8 is merely an example, but not a limitation. The configuration of the communication device (e.g., AP) in the present disclosure can comprise more or fewer components than those in FIG. 8.

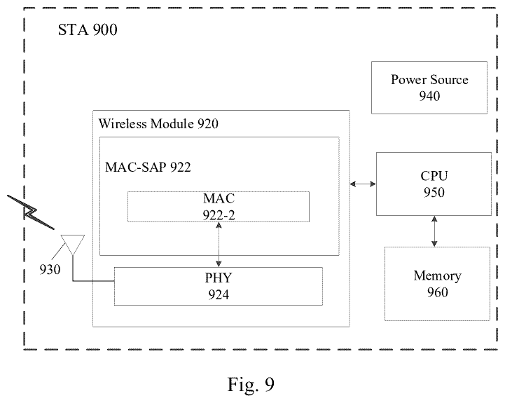

FIG. 9 shows an example configuration of a communication device 900, for example terminal (such as a STA), according to an embodiment of the present disclosure. The communication device 900 may include a wireless module 920, at least one antenna 930 (for the sake of simplicity, only one antenna is shown in FIG. 9), a power source 940, a CPU 950 and at least one memory 960. The wireless module 920 may further comprise a MAC-SAP 922 (i.e., the MAC sublayer) at least including MAC 922-2, and PHY 924 (i.e., the PHY sublayer).

The wireless module 920 and the antenna 930 may function together as a transmitter and/or a receiver of the communication device 900 (e.g., the transmitter 720/or the receiver 730 shown in FIG. 7), configured to perform related operations of methods (e.g., methods 300 and 500) as described in the present disclosure. The wireless module 920 and the CPU 950 may function together as a circuit of the communication device 900 (e.g., the circuit 710 shown in FIG. 7), configured to perform related operations of methods (e.g., methods 300 and 500) as described in the present disclosure.

Similar to FIG. 8, it should be understood that although FIG. 9 shows the MAC-SAP comprises only one MAC, more than one MACs may be comprised in the MAC-SAP. The configuration of the communication device (e.g., STA) shown in FIG. 9 is merely an example, but not a limitation. The configuration of the communication device (e.g., STA) in the present disclosure can comprise more or fewer components than those in FIG. 9.

In addition, the present disclosure further provides a communication apparatus comprising means for the communication methods for seamless roaming (e.g., methods 300 and 500) according to any embodiments of the present disclosure.

In addition, the present disclosure further provides a non-transitory computer readable storage medium storing a computer program thereon which, when being executed by a processor, implements the communication methods for seamless roaming (e.g., methods 300 and 500) according to any embodiments of the present disclosure.

In addition, the present disclosure further provides a computer program product storing instructions which, when being executed by a processor, implements the communication methods for seamless roaming (e.g., methods 300 and 500) according to any embodiments of the present disclosure.

So far, the present disclosure has disclosed communication methods for seamless roaming performed by the target AP, the source AP, and the terminal, the communication device (e.g., AP) which can function as the target AP, the source AP and the terminal, the non-transitory computer readable storage medium and the computer program product for the method. In the method of the disclosure, the target AP can directly transmit the re-association request to the terminal after completing the preparation operations of the roaming, which may omit the forwarding of the information related to that the target AP has completed the preparation operations by the source AP, thereby improving the efficiency of the roaming of the terminal. Further, since the data transmission between the terminal and the source AP can be performed till the terminal associates with the target AP, the seamless roaming of the terminal can be facilitated.

It should be noted that the above description is only some embodiments of the present disclosure and an illustration of the applied technical principles. It should be understood by those skilled in the art that the present disclosure scope involved in the present disclosure is not limited to the technical solutions resulted from specific combinations of the above technical features, but also encompasses other technical solutions resulted from any combination of the above technical features or their equivalents without departing from the above disclosed concept, for example, the technical solutions formed by replacing between the above features and the technical features with similar functions disclosed in the present disclosure (but not limited thereto).

In addition, although the operations are depicted in a specific order, this should not be understood as requiring these operations to be performed in the specific order shown or in a sequential order. In certain circumstances, multitasking and parallel processing may be beneficial. Likewise, although several specific implementation details are included in the above discussion, these should not be interpreted as limiting the scope of the present disclosure. Some features described in the context of separate embodiments can also be implemented in a single embodiment in combination. On the contrary, various features described in the context of a single embodiment can also be implemented in multiple embodiments alone or in any suitable sub-combination.

Although the subject matter has been described in a language specific to structural features and/or logical acts of methods, it should be understood that the subject matter defined in the appended claims is not necessarily limited to the specific features or acts described above. On the contrary, the specific features and actions described above are merely example forms of implementing the claims.

What is claimed is:

1. A first access point (AP), comprising:
a transmitter, configured to transmit a first request for requesting a terminal to re-associate with the first AP, and
a receiver, configured to receive a first response which is in response to the first request, wherein the first response indicates that the re-association of the terminal with the first AP succeeds.

2. The first AP of the claim 1, wherein
the receiver is further configured to:
receive a first context for re-associating the terminal with the first AP, wherein the first request is transmitted after receiving the first context, and
receive a second context after receiving the first response,
wherein the second context includes information indicating changes in contents indicated by the first context between first time and second time, wherein the first time is a start time of transmitting the first context, and wherein the second time is a start time of re-association of the terminal with the first AP or an end time of the re-association of the terminal with the first AP.

3. The first AP of the claim 2, wherein the start time of the re-association of the terminal with the first AP is a time of transmitting the first request, and wherein the end time of the re-association of the terminal with the first AP is a time of receiving the first response.

4. The first AP of the claim 2, wherein the transmitter is further configured to:
transmit a second request for the second context after receiving the first response to a second AP, wherein the second request is transmitted via either the wireless medium or the wired medium.

5. The first AP of the claim 4, wherein, at least one of:
the transmitter is further configured to transmit data to the terminal between transmitting the second request and receiving the second context, or
the receiver is further configured to receive data from the terminal between transmitting the second request and receiving the second context.

6. The first AP of the claim 2, wherein
the receiver is further configured to receive data that is not transmitted to the terminal successfully between the first time and the second time from a second AP, wherein the first context is transmitted by the second AP, and
the transmitter is further configured to transmit the data to the terminal.

7. The first AP of the claim 2, wherein the first context includes capability information of the terminal and the first AP, and information related to data transmission between the terminal and a second AP, wherein the first context is transmitted by the second AP.

8. The first AP of the claim 7, wherein the information related to data transmission between the terminal and the second AP includes a sequence number (SN) of data that has been transmitted to the terminal successfully and the SN of data buffered in the second AP and to be transmitted to the terminal.

9. The first AP of the claim 1, wherein the first request comprises parameters to be negotiated with the terminal, and wherein the first response comprises an indication indicating whether the terminal accepts the parameters.

10. The first AP of the claim 1, wherein the first request does not include static capability information of the first AP.

11. The first AP of the claim 1, wherein a key verification is performed by encrypting at least a part of the first request and the first response with a negotiated key.

12. A terminal, comprising:
a receiver, configured to receive a first request for requesting the terminal to re-associate with a first access point (AP), and
a transmitter, configured to transmit a first response which is in response to the first request, wherein the first response indicates that the re-association of the terminal with the first AP succeeds.

13. The terminal of the claim 11, wherein the first request comprises parameters to be negotiated with the terminal,
the terminal further comprises a circuit, configured to determine whether to accept the parameters, wherein the first response comprises an indication indicating whether the terminal accepts the parameters.

14. The terminal of the claim 11, wherein a key verification is performed by encrypting at least a part of the first request and the first response with a negotiated key.

15. The terminal of the claim 11, wherein the first request does not include static capability information of the first AP.

16. The terminal of the claim 11, wherein a data transmission between the terminal and a second AP is performed between first time and second time, wherein the second AP transmits a first context for re-associating the terminal with the first AP to the first AP, wherein the first time is a start time of transmitting the first context, and wherein the second time is a start time of re-association of the terminal with the first AP or an end time of the re-association of the terminal with the first AP.

17. The terminal of the claim 16, wherein the start time of the re-association of the terminal with the first AP is a time of transmitting the first request, and wherein the end time of the re-association of the terminal with the first AP is a time of receiving the first response.

18. The terminal of the claim 16, wherein a data transmission between the terminal and the first AP is performed between the first AP transmitting a second request for a second context and receiving the second context,
wherein the second context includes information indicating changes in contents indicated by the first context between the first time and second time.

19. A communication method performed by a first access point (AP), comprising:
transmitting, a first request for requesting a terminal to re-associate with the first AP, and
receiving a first response which is in response to the first request,
wherein the first response indicates that the re-association of the terminal with the first AP succeeds.

20. The method of the claim 19, further comprising:
receiving a first context for re-associating the terminal with the first AP, wherein the first request is transmitted after receiving the first context, and
receiving a second context after receiving the first response,
wherein the second context includes information indicating changes in information indicated by the first context between first time and second time, wherein the first time is a start time of transmitting the first context, and wherein the second time is a start time of re-association of the terminal with the first AP or an end time of the re-association of the terminal with the first AP.
